(19) United States
(12) Patent Application Publication
(10) Pub. No.: US 2005/0249607 A1
(43) Pub. Date: Nov. 10, 2005

(54) Apparatus and method for pumping microfluidic devices

(76) Inventor: Matthew S. Klee, Wilmington, DE (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/841,473

(22) Filed: May 10, 2004

(51) Int. Cl. F04B 19/24; F04F 1/18

(52) U.S. Cl. 417/207; 417/52

(57) ABSTRACT

An apparatus and method for pumping microfluidic devices. An apparatus for pumping microfluidic devices includes a microfluidic pumping device, a pump. The pump includes a reservoir containing a pump fluid when in operation, a heat element situated to apply heat to the pump fluid to produce evaporated pump fluid, and a reservoir outlet sized to operably couple the pump to a microfluidic device and connected to the reservoir to provide an exit from the reservoir for the pump fluid. The evaporated pump fluid increases pressure in the reservoir, causing the pump fluid to flow out of the reservoir outlet at a rate determined by the pressure, the composition, configuration and dimensions the reservoir outlet and of a flow path, and characteristics of the pump fluid.

### BACKGROUND

Devices used for analytical separations continue to evolve to smaller and smaller sizes. The current device of choice for bioseparations on a small scale is the Agilent 2100A Bioanalyzer. The 2100A Bioanalyzer separates based on capillary electrophoresis. Another analytical technique of reasonable interest is “nano separations” in liquid chromatograph (LC)-mass spectrometer (MS) systems. The nano LC-MS is based on packed capillaries and specially designed pumps which split (waste) most of the mobile phase that they pump, directing a minor fraction to the column where it moves the sample through the separation column. Nano separations systems would benefit from the availability of pumps that do not waste most of the mobile phase. Additional advantages of such pumps as described below include lower cost than conventional alternatives, less waste of mobile phase solvents, and less waste solvents to dispose of, lower power consumption, easier maintenance, and more portability.

In general, analytical microfluidic devices rely on either electro-driven separations in aqueous mobile phases (like the 2100A) or on externally-supplied pumped mobile phase sources (like the nano LC-MS). Most electro-driven separations are usually restricted to ionic or, at a minimum, water-soluble analytes. However, there are a large number of separations that are currently done by high-pressure LC (HPLC) that are not ionic or water soluble. In addition, nano-flow pumping has not been routinely extended to packed channels in microfluidic devices due to a number of complexities.

Moreover, many samples outside the biology field are not compatible with aqueous mobile phases. Further, many samples need mobile phases with significant amounts of organic solvents in order to dissolve and separate the components of interest. The high amounts of organics can arrest, impede, or degrade electro-driven mechanisms. Accordingly, microfluidic sample preparation and analysis processes would benefit from the availability of on-board pumps that could supply organic, organic-modified aqueous, or gaseous mobile phases at rate compatible with and in a format appropriate to the microfluidic devices.

### SUMMARY

What are described are an apparatus and method for pumping microfluidic devices. An apparatus for pumping microfluidic devices includes a microfluidic pumping device, a pump. The pump includes a reservoir containing a pump fluid, a heat element situated to apply heat to the pump fluid to produce evaporated pump fluid, and a reservoir outlet sized to operably couple the pump to a microfluidic device and connected to the reservoir to provide an exit from the reservoir for the pump fluid. The evaporated pump fluid increases pressure in the reservoir, causing the pump fluid to flow out of the reservoir outlet at a rate determined by the pressure increase, the size of the reservoir outlet, the composition, configuration and dimensions of the flow path, and characteristics of the pump fluid.

A system for performing microfluidic analyses includes a pump, a flow path and a microfluidic device. The pump includes a reservoir containing a pump fluid, a heat element situated to apply heat to the pump fluid to produce evaporated pump fluid, and a reservoir outlet connected to the reservoir to provide an exit from the reservoir for the pump fluid. The flow path is connected to the reservoir outlet. The microfluidic device is operably coupled to the pump via the reservoir outlet and the flow path. The evaporated pump fluid increases pressure in the reservoir, causing the pump fluid to flow out of the reservoir outlet and into the flow path towards the microfluidic device at a rate determined by the pressure increase, the size of the reservoir outlet, the composition, configuration and dimensions of the flow path, and characteristics of the pump fluid.

A portable device for performing microfluidic analyses includes one or more pumps, a flow path, a microfluidic device, a plate or a chip, and a sample input. Each pump includes a reservoir containing a pump fluid, a heat element situated to apply heat to the pump fluid to produce evaporated pump fluid, and a reservoir outlet connected to the reservoir to provide an exit from the reservoir for the pump fluid. The flow path is connected to the reservoir outlet. The microfluidic device is operably coupled to the one or more pumps via the reservoir outlet and the flow path. The evaporated pump fluid increases pressure in the reservoir, causing the pump fluid to flow out of the reservoir outlet and into the flow path towards the microfluidic device at a rate determined by the pressure increase, the size of the reservoir outlet, and characteristics of the pump fluid. The pump, flow path, and microfluidic device are etched or otherwise created on the plate or the chip. The sample input is coupled to the flow path and provides a sample aliquot that is driven by the pump fluid into the microfluidic device.

### DESCRIPTION OF THE DRAWINGS

FIG. 1 is a diagram illustrating an embodiment of an apparatus for pumping microfluidic devices.

FIG. 2 is a diagram illustrating an embodiment of an apparatus for pumping microfluidic devices.

FIG. 3 is a diagram illustrating an embodiment of a system utilizing an apparatus for pumping microfluidic devices.

FIGS. 4A-C are diagrams illustrating systems with various microfluidic devices utilizing an apparatus for pumping microfluidic devices.

FIG. 5 is a diagram illustrating a system utilizing a plurality of apparatus for pumping microfluidic devices.

FIG. 6 is a diagram illustrating a system utilizing a plurality of apparatus for pumping microfluidic devices.

FIG. 7 is a diagram illustrating an embodiment of a system utilizing an apparatus for pumping microfluidic devices.

FIG. 8 is a diagram illustrating an embodiment of a flow injection analysis system utilizing an apparatus for pumping microfluidic devices.

FIG. 9 is a diagram illustrating an embodiment of a system utilizing a plurality of apparatus for pumping microfluidic devices to provide mobile phase gradients.

### DETAILED DESCRIPTION

An apparatus and method for pumping of liquid or gas mobile phases in analytical microfluidic devices is described herein. The apparatus and method utilize controlled evaporation of liquids to pump the mobile phase. The apparatus and method take advantage of the fact that liquids evaporate at a rate proportional to the heat (watts) supplied. If the liquid is contained in a sealed vessel with one outlet and with appropriate temperature control, the rate of evaporation can be accurately controlled. Moreover, the rate of evaporation can be calculated as a function of the liquid constants, vessel constants, and the heat supplied. If the rate of evaporation is controlled, the pressure within the sealed vessel and the resulting flow to the microfluidic device can be controlled. Further, the pressure increase and the resulting flow can be calculated from the rate of evaporation. Consequently, by controlling the temperature (through the heat supplied), the resulting flow is controlled. By taking advantage of these known principles, the apparatus and method described herein achieve this control.

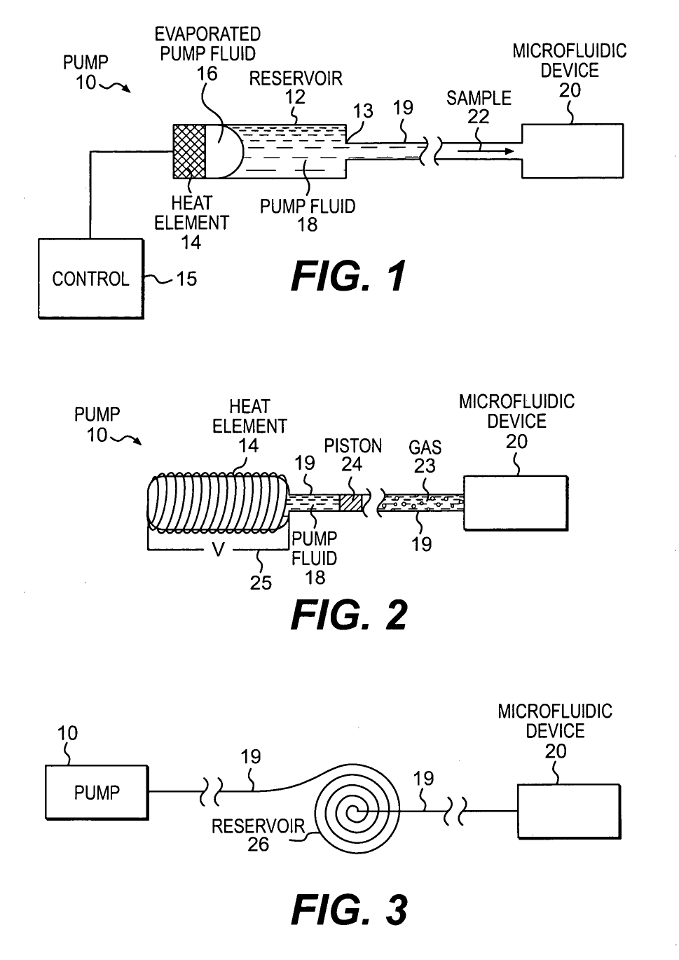

With reference now to FIG. 1, illustrated is an apparatus for pumping analytical microfluidic devices, pump 10. The pump 10 is itself a microfluidic device, a microfluidic pumping device. As shown, pump 10 includes a reservoir 12, a reservoir outlet 13, a heat element 14, and a control 15. The control 15 controls the heat element 14 and the heat supplied by the heat element 14 in any manner known to one of skill in the art. For example, the control 15 may control the temperature of the supplied heat by controlling the amount of power supplied to the heat element 14. The heat element 14 may be a separate structure or component from the reservoir or may be integrated with the reservoir as one structure. The heat element 14 may be, e.g., a coil, plate, sleeve, or other structure suitable to provide heat to the reservoir 12 and the pump fluid 18. The control 15 may also monitor the temperature of a pump fluid (e.g., a solvent) 18, the flow rate of the pump fluid 18, the amount of pump fluid 18, and any other variable necessary for controlling and monitoring the pump 10 in manners known to one of skill in the art.

The reservoir 12 contains the pump fluid 18, and when heat element 14 has supplied and/or is supplying heat of sufficient temperature, evaporated pump fluid 16. If the heat element 14 is supplying increasing heat of sufficient temperature, the amount of evaporated pump fluid 16 will increase. The heat migrates over time so that the evaporated pump fluid 16 stays evaporated. The evaporated pump fluid 16 will continue to expand, forcing the pump fluid 18 out of the reservoir 12. As a result, the pump fluid 18 will flow to an analytical microfluidic device 20.

Based on the above principles, an increasing amount of evaporated pump fluid 16 results in increased pressure and, therefore, increased flow to microfluidic device 20. If the temperature of the supplied heat is reduced to a sufficient level, the evaporated pump fluid 16 remaining in the reservoir 12 will begin to condense, resulting in decreased pressure and, therefore, decreased flow to the microfluidic device 20. If the temperature of the supplied heat is held at a certain level, the flow will stop. If the temperature of the supplied heat is reduced sufficiently or if the heat is removed entirely, the pressure may decrease enough to create a vacuum into the reservoir 12, reversing the flow into the reservoir 12. A cooling element (not shown) may be added to the pump 10 to increase the temperature reduction and therefore, the rate of condensation and pressure drop, resulting in a more rapid decrease and reversal in flow.

With continued reference to FIG. 1, the pump 10 is connected to the microfluidic device 20 via a flow path (e.g., a microfluidics channel or a small tube) 19 connected to the reservoir outlet 13. The flow path 19 may be of any length, width, or shape necessary for a desired implementation and may include additional components along its length. Further, the pump 10 is typically sized to be of similar dimensions as separation sections of the instrumentation in which and with which the pump 10 is used. A typical microfluidic device 20 is a few centimeters by a few centimeters (e.g., 2×2 cm), with channel dimensions in the low tens of microns (e.g., 10×30 μm). Consequently, the pump 10 may be similarly scaled and integrated with the microfluidic device 20 or simply coupled to the microfluidic device 20.

If integrated with the microfluidic device 20, the pump 10 may be etched (or otherwise formed) on the same board as the microfluidic device 20 using known etching (or other) methods. The pump 10 may be etched on a chip or plate (e.g., steel). If coupled to the microfluidic device 20, the pump 10 may be etched on a disposable chip that is connected to the microfluidic device 20 and removed when the pump fluid 18 in the reservoir is exhausted. Similarly, the reservoir 12 alone may be etched on a disposable chip that is removed from pump 10 when the pump fluid 18 supply is exhausted. Indeed, the pump 10 may be fabricated using any know manner of fabricating micro-devices.

The material chosen for the pump 10 components and the flow path 19 may be based in part on the type of pump fluid (e.g., solvent) 18 that may be used. It may be desirous to construct the components and the channel from a material that is opposite in nature from the pump fluid 18 (e.g., hydrophilic vs. hydrophobic). For example, a teflon or like material (hydrophobic) may be used. This may prevent a hydrophilic pump fluid 18 from wetting the component and channel walls, therefore decreasing resistance to the flow of the pump fluid 18 and ensuring a defined front miniscus. Likewise, in an existing pump 10, the choice of the pump fluid 18 may be influenced by the material used for the pump components and the microfluidics channel.

If the flow generated by the pump 10 is sufficient, the pump fluid 18 drives a sample 22 into and through the microfluidic device 20. The sample 22 may be a second liquid. The pump fluid 18 is the mobile phase in this implementation. The pump fluid 18 may be non-aqueous or aqueous, although the pump fluid 18 should evaporate at low-enough temperature to be practical and have other characteristics that do not hinder its effectiveness as the mobile phase (e.g., the pump fluid 18 should be miscible with the sample 22). With these factors in mind, the pump 10, therefore, enables substantial flexibility in the choice of a mobile phase.

Alternatively, the pump fluid 18 may drive a piston where when it is desirable to isolate contact of the pump fluid 18 with a secondary fluid, gas, or sample substance. With reference now to FIG. 2, the pump 10 includes a piston 24 that is situated between the pump fluid 18 and the secondary fluid or gas 23. The piston 24 may be a fluid with a high boiling point (i.e., sufficiently higher than the pump fluid 18 so that the piston fluid will not evaporate) that is immiscible with the pump fluid 18. The piston fluid may also be chosen so as to avoid wetting the walls of the flow path 19. Configured as shown in FIG. 2, the pump fluid 18 drives the piston 24 which in turn drives the secondary fluid or gas 23 into the microfluidic device 20. The secondary fluid or gas may be the sample 22 or may be the mobile phase driving the sample 22. An embodiment of an apparatus for pumping microfluidic devices is shown in which the pump fluid 18 drives a gas 23 into the microfluidic device 20.

A system in which the pump 10 is pumping fluid or gas may include a reservoir. FIG. 3 illustrates a system utilizing an embodiment of an apparatus for pumping microfluidic devices, e.g., the embodiment shown in FIG. 2. As shown, the flow path 19 in the system includes a reservoir 26. The reservoir 26 may include an amount of gas necessary for the desired analysis to be performed in the microfluidic device 20.

With reference again to FIG. 2, shown is an embodiment of the heat element 14. The embodiment of the heat element 14 shown includes a heating coil wound around the reservoir 12. A voltage supply 25 may be connected to the heating coil to provide the necessary voltage to activate and run the heating coil.

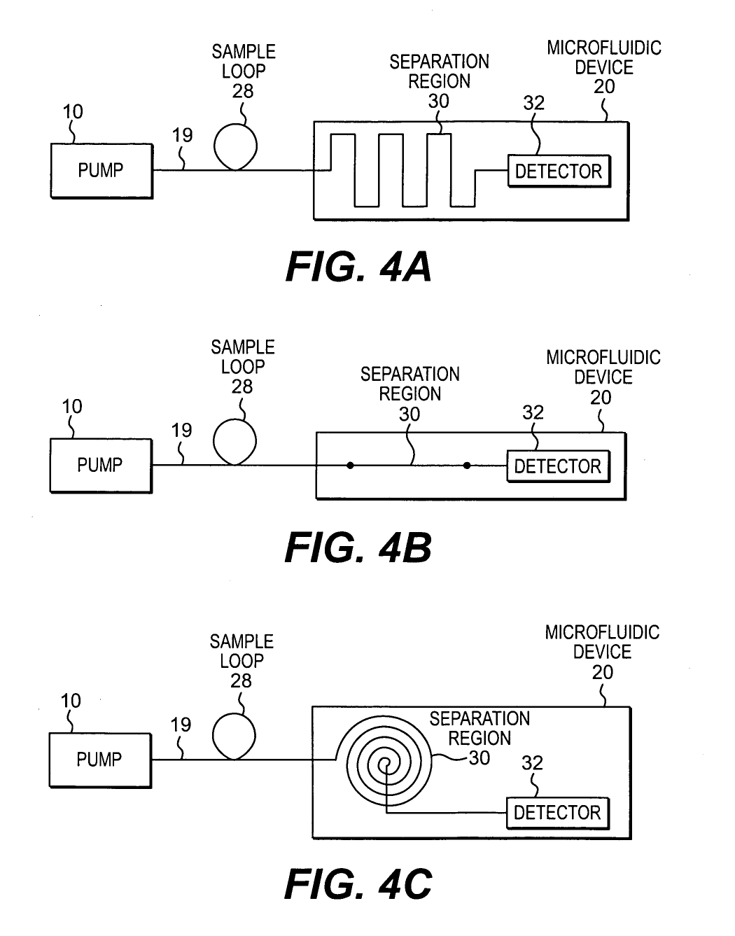

With reference now to FIGS. 4A-4C, shown are various embodiments of a system utilizing an embodiment of an apparatus for pumping microfluidic devices, e.g., the embodiment shown in FIG. 1. In the systems shown, the pump fluid 18 is the mobile phase driving the sample 22 into and through the microfluidic device 20. As shown, the flow path 19 includes a sample loop 28. The sample 22 is inserted into the mobile phase (e.g., the pump fluid 18) and, hence, into the flow path 19, via the sample loop 28.

For example, the sample loop 28 may include a quantity of sample 22 and a switch (not shown) that diverts the pump fluid 18 from the flow path 19 into the sample loop 28. When the switch is activated, the pump fluid 18 enters the sample loop 28 and drives the quantity of sample 22 in the sample loop 28 out of the sample loop 28 and into the flow path 19. Once the sample 22 is driven out of the sample loop 28, the switch may be deactivated and the pump fluid 18 will resume traveling through the flow path 19, driving the inserted sample 22 into and through the microfluidic device 20. In the meantime, the sample loop 28 may be refilled with a quantity of sample 22.

The process described in the preceding paragraph can be repeated again, as many times as necessary for multiple analyses to be performed in the microfluidic device 20. In this manner, the system shown in FIGS. 4A-4C enables repeated injections of small amounts of isolated samples 22 into the microfluidics flow path. Greater instrument performance, reliability and usability can result from the greater integration of system components. By inserting the sample 22 into the mobile phase (e.g., the pump fluid 18), a small amount of isolated sample 22 may be efficiently provided to microfluidic device 20 for chromatographic separation.

With reference again to FIGS. 4A-4C, shown are microfluidic devices 20 with a variety of separation regions 30 and detectors 32. FIG. 4A illustrates a microfluidic device 20 (i.e., a liquid chromatograph) with a serpentine separation region 30 and a connected detector 32. The detector 32 detects the chromatographic elution of the individual components of the sample 22, identifying the individual components and/or the amount of each. FIG. 4B illustrates a microfluidic device 20 (i.e., a liquid chromatograph) with a linear separation region 30 and a connected detector 32. FIG. 4C illustrates a microfluidic device 20 (i.e., a liquid chromatograph) with a spiral separation region 30 and a connected detector 32. Other microfluidic devices 20 and other separation regions 30 may be used.

As discussed above, as heat is applied to the reservoir 12 by the heat element 14, the evaporated pump fluid 16 will expand. The pump fluid 18 will be forced out of the reservoir 12 by the resulting pressure increase until no pump fluid 18 remains in the reservoir 12. At this point, the reservoir 12 will be exhausted. The evaporated pump fluid 16 may continue to expand into the flow path 19 for some time, continuing to force the pump fluid 18 to flow to the microfluidic device 20. The amount of continued expansion of the evaporated pump fluid 16 will be limited based on pump fluid, reservoir and other component (e.g., flow path 19) constants, the maximum heat supplied, and heat transfer characteristics of the evaporated pump fluid 16. At the point which the expansion of the evaporated pump fluid 16 ceases, the flow of the pump fluid 18 will cease. For many types of analysis performed in microfluidic devices 20, a continuous flow of the mobile phase (e.g., the pump fluid 18) is necessary or desirous until the analysis is complete. If the maximum expansion of the evaporated pump fluid 16 is reached or the flow of the pump fluid 18 otherwise stops before the analysis is complete, the flow will not be continuous.

Moreover, evaporated pump fluid 16 may interfere with analysis performed by the microfluidic device 20. Therefore, it may be necessary to prevent the evaporated pump fluid 16 from expanding to the point at which evaporated pump fluid 16 enters the microfluidic device 20. It may also be desirous or necessary to prevent the evaporated pump fluid 16 from flowing beyond a certain point in the flow path 19 (in many cases the evaporated pump fluid 16 may reach its maximum expansion prior to flowing significantly into the flow path 19, let alone the microfluidic device 20).

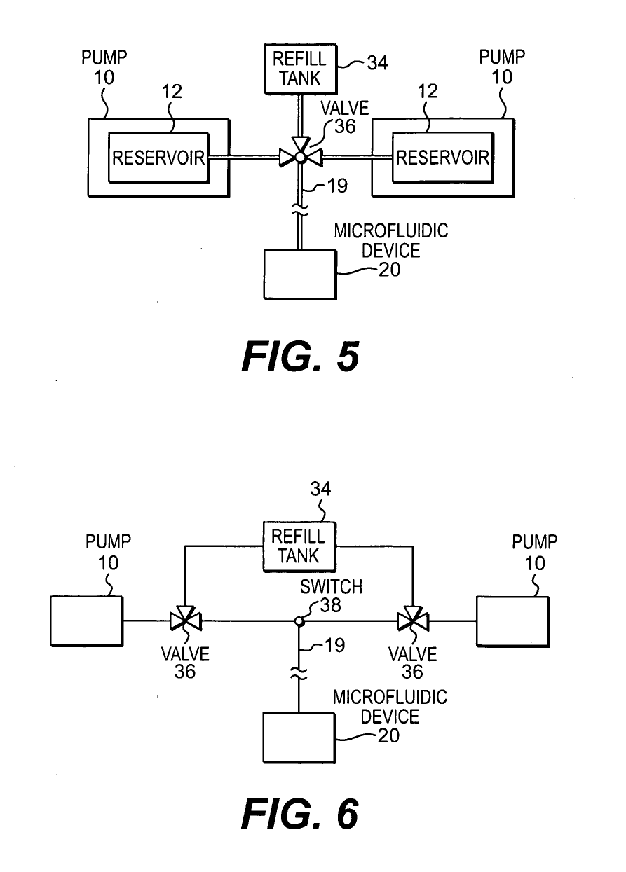

With reference now to FIG. 5, shown is a system that addresses these issues. Specifically, the system shown enables the continuous flow of the mobile phase and may prevent evaporated pump fluid 16 from entering the microfluidic device 20 or beyond a certain point in the flow path 19. The system includes two pumps 10, a refill tank 34, and a valve 36. Additional pumps 10 may be added to the system. Further, although not shown, other components may be added to the flow path 19, such as the gas reservoir 26 shown in FIG. 3 or fluid reservoirs.

In operation, a first pump 10 is activated and pumps the mobile phase (e.g., the pump fluid 18) until a certain switching point. The switching point may be, for example, when the evaporated pump fluid 16 reaches its maximum expansion, when the reservoir 12 is exhausted, when the flow of the pump fluid 18 stops, or when the evaporated pump fluid 16 reaches the valve 36. The control 15 (not shown in FIG. 5) may monitor the system and determine when the certain switching point is met. When the switching point is met, the valve 36 switches from the first pump 10 to a second pump 10. The valve 36, which may be controlled by the control 15, may achieve this by closing the connection from the first pump 10 via the flow path 19 to the microfluidic device 20 and opening a connection from the second pump 10 via the flow path 19 to the microfluidic device 20. The second pump 10 may be activated at a time sufficiently prior to the switching point so that the second pump 10 pumps pump fluid 18 into the flow path 19 as soon as the valve 36 switches to the second pump 10. In this manner, the system maintains continuous pumping of the mobile phase.

When the reservoir 12 in a pump 10 is exhausted, the exhausted reservoir 12 may be swapped with a full reservoir 12. Alternatively, the exhausted reservoir 12 may simply be refilled. With continued reference to FIG. 5, the system shown enables the refilling of an exhausted reservoir 12 via pump fluid 18 stored in the refill tank 34. The refill tank 34 is connected to the pumps 10, and hence the reservoirs 12, via the valve 36. As shown, when the valve 36 closes the connection from the first pump 10 to the microfluidic device 20, the valve 36 opens a connection from the refill tank 34 to the first pump 10, specifically to the reservoir 12 of the first pump 10.

Simultaneously, or nearly so, the heat element 14 of the first pump 10 may be turned off and the reservoir 12 allowed to cool. A cooling element may also be activated to increase the cooling of the reservoir 12. As discussed above, this cooling of the reservoir 12 causes the evaporated pump fluid 16 to condense, creating a vacuum in the reservoir 12 and reversing flow into the reservoir 12. The vacuum and reversed flow draw the pump fluid 18 out of the refill tank 34 and into the reservoir 12. As a result, the pump fluid 18 in the refill tank 34 will refill the reservoir 12 of the first pump 10. The valve 36 may close the connection from the refill tank 34 to the first pump 10 if the reservoir 12 is filled with the pump fluid 18. The control 15 may control the valve 36 and the refill operation.

With continued reference to FIG. 5, other means, including gravity, may be used to cause the refill tank 34 to refill the reservoir 12 of the first pump 10. Moreover, when the valve 36 closes the connection from the second pump 10 to the microfluidic device 20 and re-opens the connection from the first pump 10 to the microfluidic device 20, the re-filled reservoir 12 of the first pump 10 enables the first pump 10 to maintain continuous pumping of the mobile phase, as described above. Further, when the valve 36 switches from the second pump 10 to the first pump 10, the valve 36 opens a connection from the refill tank 34 to the second pump 10, specifically to the reservoir 12 of the second pump 10. As a result, the refilling process described herein can be performed with the second pump 10.

If additional pumps 10 are connected to the system, these additional pumps can provide continuous pumping and be refilled in like manners. For example, the valve 36 may sequentially switch between the pumps 10, opening and closing connections to the microfluidic device 20 and the refill tank 34 as necessary to maintain continuous pumping and refill one pump 10 at a time. Alternatively, the valve 36 may maintain one open connection from a pump 10 to the microfluidic device 20 while opening a connection from the refill tank 34 to some or all of the remaining pumps 10 simultaneously. In this configuration, the refill tank 34 refills a plurality of pumps 10 simultaneously. Likewise, a system may comprise multiple valves 36 and/or multiple refill tanks 34 enabling still further configurations and operations as can be easily determined by one of skill in the art.

With reference now to FIG. 6, illustrated is another system utilizing a plurality of apparatus for pumping microfluidic devices. The system comprises multiple valves 36 and a single refill tank 34. Alternatively, the single refill tank 34 may be replaced by multiple refill tanks 34. As shown, there are two pumps 10, each connected to the refill tank 34 with a valve 36. The valves 36 also connect the pumps 10 to the microfluidic device 20 via a switch 38 and the flow path 19. The switch 38 switches between one pump 10 and the other pump 10, connecting the pumps 10 to the microfluidic device 20. The control 15 (not shown in FIG. 6) may control the switch 38. The switch 38 may switch between the pumps 10 based on a certain switching point as described above. The system may be configured with a plurality of additional pumps 10 connected to the switch 38 in the manner shown in FIG. 6 (e.g., with a pump 10 connected via a valve 36 to the refill tank(s) 36 and to the switch 38).

An advantage of the systems described herein, in addition to providing continuous pumping and easy refilling, is that such systems can be provided on a single chip or plate due to the size and characteristics of the pump 10. Due to their nano-size, multiple pumps 10 may be etched on a chip or plate. The refill tanks 34, valves 36 and switches 38 are similarly sized and may be similarly etched. Accordingly, the systems described enable greater miniaturization and compactness of microfluidic device systems than presently possible.

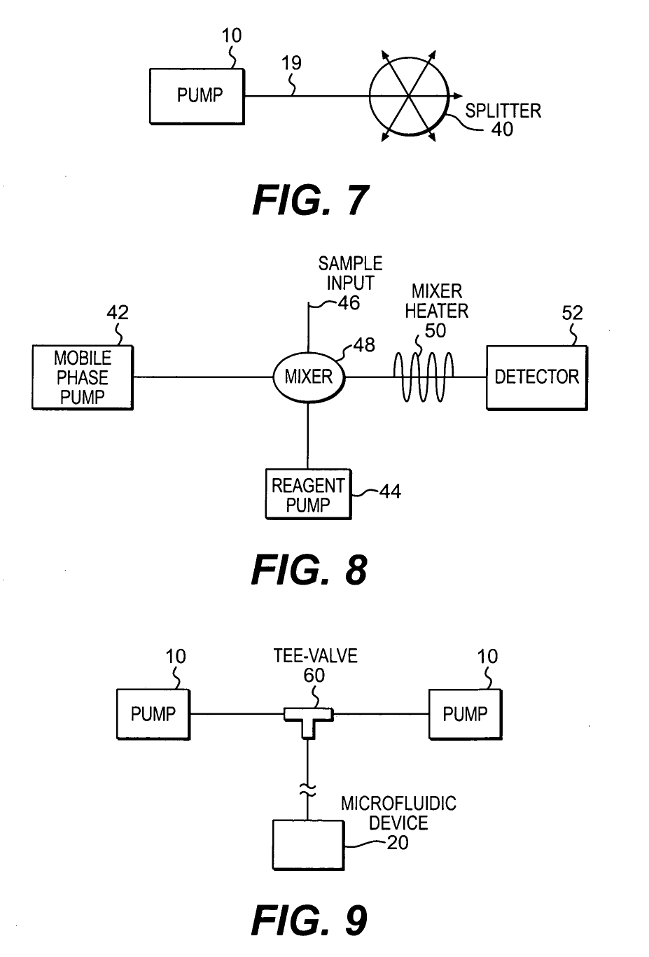

As described above, the apparatus for pumping microfluidic devices may be utilized with a number of components and in different configurations. With reference now to FIG. 7, shown is a system including a pump 10 connected to a stream splitter 40 via a flow path 19. The stream splitter 40 splits the mobile phase (e.g., the pump fluid 18) onto multiple paths, enabling the pump 10 to provide a mobile phase to multiple microfluidic devices 20 or as a means of reducing flow to a given device (flow reduction). If the pump fluid 18 is not the mobile phase, the stream splitter 40 may be placed on the flow path 19 at a location prior to where the pump fluid 18 encounters the mobile phase. The description herein is not intended to provide an exhaustive description of the various systems, configurations, and components with which the apparatus for pumping microfluidic devices may be utilized.

The pumps 10 described herein are not limited to providing pump fluid 18 or the mobile phase. Likewise, the pumps 10 and systems utilizing the pumps 10 may be provided on a single chip or plate. Accordingly, the apparatus for pumping microfluidic devices may also facilitate the miniaturization of analytical techniques that are not currently miniaturized. For example, the apparatus for pumping microfluidic devices facilitates the miniaturization of the Flow Injection Analysis (FIA) technique. In FIA, a sample is mixed with a chemical reagent that reacts with a certain component(s). If there is a chemical reaction, the certain component(s) is known to be present. As is indicated by its name, FIA needs flow in order for the analysis to take place. A combination of pumps 10 could supply the reagents, diluents, gas segmentation (bubbles) and transport flow (e.g., the mobile phase) used in FIA. By using a combination of pumps 10, complete sample handling may be accomplished on a single-chip or plate.

With reference now to FIG. 8, illustrated is a FIA system utilizing a plurality of pumps 10. The FIA system includes a mobile phase pump 42, a reagent pump 44, a sample input 46, a mixer 48, a mixer heater 52, and a detector 54. The sample input 46 may also be provided by a pump 10. If diluents and/or gas segmentation is necessary for the FIA being performed, a diluent pump and/or gas pump may also be included. The pumps 42-46 may operate and be configured as described above for the pump 10. The mobile phase pump 42 evaporates a pump fluid and provides the flow necessary for the FIA. Alternatively, the reagent may be the mobile phase. For example, the reagent may be the pump fluid 18 that is evaporated or the reagent may be separated from the pump fluid 18 by a piston 24 and driven by the pump fluid 18 as described-above. If the reagent is the mobile phase, then the mobile phase pump 42 and the reagent pump 44 may be replaced by a single pump.

With reference now to FIG. 9, illustrated is a system utilizing a plurality of pumps 10 to form mobile phase gradients. As shown, the pumps 10 are joined by a coupling device 60 to a flow path 19. Each pump 10 includes different effluents; accordingly, combining together effluent of the pumps 10 enables different mixtures of the mobile phases. The relative flow rates of liquids from the pumps 10 or the time-gated selection of flow from each pump dictates the composition of the mixture. By appropriately applying heat independently to the pumps 10, e.g., via separate heat elements 14 for each pump 10, relative flow rates may be adjusted. By using a valve or combination of valves (e.g., a proportioning valve(s)) within the coupling devices of constant flow or pressure, the relative amounts of fluids from each pump can be controlled by the relative duration of time each stream is allowed to pass to the combined flow stream. In this manner, the system shown in FIG. 9 can provide flexibility in mobile phase composition, analogous to gradient elution separations common to traditional scale separations.

The apparatus for pumping microfluidic devices may also be used for Solid Phase Extraction (SPE). A system, such as the systems shown in FIGS. 5 or 6, may include multiple pumps 10, each with a different solvent as the pump fluid 18. A weak solvent in a first pump 10 may be used as a sample preparation, pumped through the microfluidic device 20 to prepare the microfluidic device 20 for the sample 22. A moderate solvent in a second pump 10 may be used as the mobile phase for the chromatographic separation. A strong solvent in a third pump 10 may be used as a drive-off solvent to cleanse the microfluidic device 20 after the analysis is performed.

The pump 10 may also be used to activate a diaphragm valve. When the pump 10 is activated and the heat element 14 provides heat, the pump 10 may supply pressure to the diaphragm valve, deforming the diaphragm until it closes an associated channel or opening. When the heat element stops providing heat, the evaporated pump fluid 16 will condense, the pressure will reduce, and the diaphragm will reform, opening the associated channel or opening.

As is apparent from the description herein, the apparatus and method for pumping microfluidic devices have a significant number of advantages. These advantages may include, for example: no pulsation related to mechanical pumping; no moving parts; no pump fluid (e.g., solvent) waste due to splitting; environmentally friendly and minimal clean-up due to minimized waste; effective coupling to nano-scale devices; enhanced portability of microfluidic systems; flexibility in mobile phase composition (e.g., non-aqueous or gaseous); predictable relationships between temperature, pressure, flow and watts supplied; low cost; multiple simple construction approaches; ability to do standard LC separations on microfluidic devices; sample preparation (dilution, transfer, addition of reagents, rinsing, etc.); freedom from needing external mobile phase reservoirs; less void volume/time/delay during mobile phase ramping; and many others inherent from the above description.

These advantages enable many different applications utilizing the apparatus and method for pumping microfluidic devices. For example, a small, portable, disposable FIA system may be built as described above. The FIA system illustrated in FIG. 8 may be implemented on a single chip or plate and contained in a small box. Such a FIA system could be used for a Homeland Defense implementation. For example, the FIA system could be loaded with reagents for detecting the presence of Ricin. A small sample is collected and input into the FIA system. If the Ricin is present, the FIA system will indicate such. After being used, the FIA system is disposed. Since there is no waste, the FIA system can be disposed in an environmentally friendly and safe way.

It should be noted that the illustrations provided by the Figures herein are not intended to be to scale. Moreover, the arrangement of various elements in the Figures are not intended to indicate a particular orientation (e.g., above or below) of the elements.

The foregoing description provides illustration and description, but is not intended to be exhaustive or to limit the invention to the embodiments disclosed. Modifications and variations are possible consistent with the above teachings or may be acquired from practice of the embodiments disclosed. Therefore, it is noted that the scope is defined by the claims and their equivalents.

1. An apparatus for pumping microfluidic devices, comprising:
a pump including:
a reservoir containing a pump fluid;
a heat element situated to apply heat to the pump fluid to produce evaporated pump fluid; and
a reservoir outlet sized to operably couple the pump to a microfluidic device and connected to the reservoir to provide an exit from the reservoir for the pump fluid;
wherein the evaporated pump fluid increases pressure in the reservoir, causing the pump fluid to flow out of the reservoir outlet at a rate determined by the pressure, the reservoir outlet, and characteristics of the pump fluid.

2. The apparatus of claim 1 wherein the reservoir outlet provides the only exit for the pump fluid from the reservoir.

3. The apparatus of claim 1 wherein the reservoir outlet has a diameter that is in the range of 10 to 90 μm.

4. The apparatus of claim 1 wherein the heat element and the reservoir are formed as one structure.

5. The apparatus of claim 1 further comprising a control that controls the heat element.

6. The apparatus of claim 1 further comprising a plate, wherein the pump is etched on the plate.

7. A system for performing microfluidic analyses, comprising:
a pump including:
a reservoir containing a pump fluid;
a heat element situated to apply heat to the pump fluid to produce evaporated pump fluid; and
a reservoir outlet connected to the reservoir to provide an exit from the reservoir for the pump fluid;
a flow path connected to the reservoir outlet; and
the microfluidic device operably coupled to the pump via the reservoir outlet and the flow path, wherein the evaporated pump fluid increases pressure in the reservoir, causing the pump fluid to flow out of the reservoir outlet and into the flow path towards the microfluidic device at a rate determined by the pressure, the reservoir outlet, and characteristics of the pump fluid.

8. The system of claim 7 further comprising:
a sample loop coupled to the flow path and containing a sample, wherein the pump fluid drives the sample into the microfluidic device.

9. The system of claim 8 wherein the sample loop intermittently injects amounts of sample into the pump fluid.

10. The system of claim 7 further comprising:
a reservoir coupled to the flow path and containing a gas or liquid wherein the pump fluid drives the gas or liquid into the microfluidic device.

11. The system of claim 7 wherein the microfluidic device includes a separation region and a detector.

12. The system of claim 7, wherein the pump is a first pump, further comprising:
a second pump including:
a reservoir containing a pump fluid;
a heat element situated to apply heat to the pump fluid to produce evaporated pump fluid; and
a reservoir outlet connected to the reservoir to provide an exit from the reservoir for the pump fluid; and
one or more valves connected to the first pump reservoir outlet and the second pump reservoir outlet, wherein the valve selectively couples the first pump and the second pump to the flow path.

13. The system of claim 12 further comprising:
a refill tank connected to the valve, wherein the valve selectively couples the refill tank to the first pump and the second pump so that the refill tank selectively refills the first pump reservoir and the second pump reservoir.

14. The system of claim 7 further comprising:
a splitter, connected to the flow path, that reduces the flow rate of pump fluid towards the microfluidic device.

15. The system of claim 7, wherein the pump is a mobile phase pump providing the pump fluid as a mobile phase for flow injection analysis (FIA), further comprising:
a reagent pump, including:
a reservoir containing a reagent;
a heat element situated to apply heat to the reagent to produce evaporated reagent; and
a reservoir outlet connected to the reservoir to provide an exit from the reservoir for the reagent;
a sample input that provides a sample;
a mixer, coupled to the flow path, the reagent pump, and the sample input, that mixes the sample and reagent to form a mixed composition; and
a FIA detector, coupled to the flow path, that performs the FIA on the mixed composition, wherein the mobile phase drives the mixed composition into the detector.

16. The system of claim 15 further comprising a heater coupled to the mixer that heats the mixed composition.

17. The system of claim 7, wherein the pump is a first pump and the pump fluid is a first effluent, further comprising:
a second pump including:
a reservoir containing a second effluent;
a heat element situated to apply heat to the second effluent to produce evaporated second effluent; and
a reservoir outlet connected to the reservoir to provide an exit from the reservoir for the second effluent; and
a tee connected to the first pump reservoir outlet and the second pump reservoir outlet, wherein the tee couples both the first pump and the second pump to the flow path so that a mix of the first effluent and the second effluent is driven towards the microfluidic device.

18. The system of claim 7, wherein the pump is a first pump and the pump fluid is a first effluent, further comprising:
a second pump including:
a reservoir containing a second effluent;
a heat element situated to apply heat to the second effluent to produce evaporated second effluent; and
a reservoir outlet connected to the reservoir to provide an exit from the reservoir for the second effluent; and
a proportioning valve connected to the first pump reservoir outlet and the second pump reservoir outlet, wherein the proportioning valve couples both the first pump and the second pump to the flow path so that the ratio of the mix of the first effluent and the second effluent can be adjusted.

19. The system of claim 7 further comprising a plate or a chip, wherein the pump, flow path, and microfluidic device are etched on the plate or the chip.

20. v A portable device for performing microfluidic analyses, comprising:
one or more pumps, each pump including:
a reservoir containing a pump fluid;
a heat element situated to apply heat to the pump fluid to produce evaporated pump fluid; and
a reservoir outlet connected to the reservoir to provide an exit from the reservoir for the pump fluid;
a flow path connected to the reservoir outlet;
the microfluidic device operably coupled to the one or more pumps via the reservoir outlet and the flow path, wherein the evaporated pump fluid increases pressure in the reservoir, causing the pump fluid to flow out of the reservoir outlet and into the flow path towards the microfluidic device at a rate determined by the pressure, the reservoir outlet, the flow path, and characteristics of the pump fluid;
a plate or a chip, wherein the pump, flow path, and microfluidic device are etched on the plate or the chip; and
a sample input, coupled to the flow path, wherein the sample input provides a sample that is driven by the pump fluid into the microfluidic device.
